(19) United States
(12) Patent Application Publication
(10) Pub. No.: US 2003/0058525 A1
(43) Pub. Date: Mar. 27, 2003

(54) Extended band optical fiber amplifier

(76) Inventor: Parviz Tayebati, Boston, MA (US)

Correspondence Address: Mark J. Pandiscio, Pandiscio & Pandiscio, 470 Totten Pond Road, Waltham, MA, 02154, US

(21) Appl. No.: 10/017,741

(22) Filed: Dec. 14, 2001

Related U.S. Application Data
(63) Continuation of application No. 09/526,581, filed on Mar. 16, 2000, now abandoned.
(60) Provisional application No. 60/124,569, filed on Mar. 16, 1999.

(51) Int. Cl. H01S 3/00

(52) U.S. Cl. 359/341.3; 359/333

(57) ABSTRACT

Apparatus and methods are disclosed for amplifying optical signals in a fiber optic system where the optical signals have a wavelength of at least N nanometers. The apparatus comprises means for providing a pump wavelength of (N−X) nanometers, where the wavelength (N−X) is not so short as to excite higher energy levels in the fiber optic system. The method comprises providing a pump wavelength of (N−X) nanometers, where the wavelength (N−X) is not so short as to excite higher energy levels in the fiber optic system.

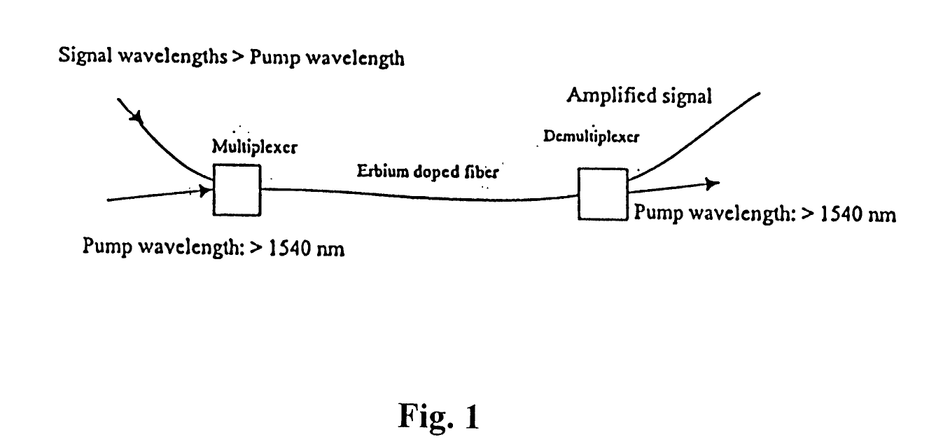

Erbium doped fiber amplifiers typically pumped using a 980 nm or 1480 nm pump laser typically have a low gain in wavelengths range longer than 1560 nm.

In FIGURE, I show a method to achieve efficient optical amplification in the long wavelength range (>1560 nm) using a high power laser source with a wavelength slightly shorter wavelength than the shortest signal wavelength in the long wavelength band. For example if it is desirable to have signal wavelengths ranging from 1561 nm-1620 nm, the pump must be at a wavelength shorter than 1561 nm but no too short as to excite higher energy levels. By avoiding excitation of higher energy levels, only lower energy levels corresponding to wavelengths of signals are pumped therefore achieving high efficiency. The pump laser at such wavelengths may be achieved by optical amplification of a DFB or a Fabry-Perot semiconductor laser or it could simply be a high power DFB or Fabry-Perot laser.

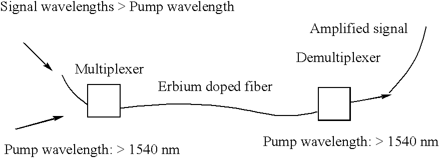

What is claimed is:

1. I claim the invention described and illustrated above.

2. A method for amplifying optical signals in a fiber optic system where the optical signals have a wavelength of at least N nanometers, comprising providing a pump wavelength of (N−X) nanometers, where the wavelength (N−X) is not so short as to excite higher energy levels in the fiber optic system.

3. Apparatus for amplifying optical signals in a fiber optic system where the optical signals have a wavelength of at least N nanometers, comprising means for providing a pump wavelength of (N−X) nanometers, where the wavelength (N−X) is not so short as to excite higher energy levels in the fiber optic system.
